(19) United States
(12) Patent Application Publication
(10) Pub. No.: US 2017/0067282 A1
(43) Pub. Date: Mar. 9, 2017

(54) Two part window

(71) Applicant: Iciar de las casas Rodriguez, Madrid (ES)

(72) Inventor: Iciar de las Casas Rodriguez, Madrid (ES)

(21) Appl. No.: 15/119,389

(22) PCT Filed: Dec. 29, 2014
(86) PCT No.: PCT/ES2014/070988

§ 371 Date: Aug. 17, 2016

(30) Foreign Application Priority Data
Feb. 18, 2014 (ES) P 201430217

(51) Int. Cl. E06B 3/66; E06B 3/02; E06B 3/10

(52) U.S. Cl. CPC E06B 3/6621; E06B 3/10; E06B 3/025; E06B 3/6612; E06B 3/6617

(57) ABSTRACT

Improved two pieces window formed from a micro-laminated wood frame and several glass sheets with a built-in air chamber and that is constituted by a frame made of micro-laminated woods, glued together with strong adhesive and a closing sheet constituted, from the outside to the inside, by a block of two laminated glass sheets and a sheet of thick tempered glass of a larger size, and separated by a vacuum chamber.

### OBJECT OF THE INVENTION

The proposed invention refers to a new window layout of the type of windows made up starting with a micro-laminated wood frame and several glass sheets with a built-in air chamber.

### FIELD OF THE INVENTION

The field of the invention is the construction materials manufacturing industry, especially woodwork shops, glass manufacturing factories and accessories for Windows.

### BACKGROUND OF THE INVENTION

There is a lot of background on Windows.

There is also some background regarding Windows formed by a wooden frame and glass as enclosure.

There are already many less incorporating a frame of laminated wood and an enclosure made of three sheets of glass.

But the characteristics of this invention, with a one piece frame made out of laminated woods, with an enclosure of three sheets of glass, where two are glued and separated by an air chamber and also incorporating in its closing a decompression chamber and varied airtight elastic sheets, are new and have not been disclosed all together in any embodiment.

The inventor is not aware of any prior art that incorporates the layout presented by the current invention, nor the advantages inherent to this layout.

### DESCRIPTION OF THE INVENTION

The proposed invention refers to a new window layout of the type of windows made up starting with a micro-laminated woods frame and several glass sheets with a built-in air chamber and that is constituted by a frame made of micro-laminated woods, glued together with strong adhesives and a closing sheet constituted, from the outside to the inside, by a block of two laminated glass sheets and a sheet of thick tempered glass of a larger size, and separated by a vacuum chamber.

The laminated glass sheets present a triangular shaped elastic element that encircles them along the perimeter and the sheet of tempered glass presents at all its perimeter a cushion type elastic element.

The closing space between the frame and the closing sheet is occupied by a decompression chamber attached to the framework, whose decompression chamber shows an elastic sheet adhered to by its free side that serves as a stop for the closing fitting placed on the tempered glass by means of an adhesive that entails a drive handle.

### DESCRIPTION OF THE DRAWINGS

A sheet of drawings is attached for a better understanding of the invention, where the following is shown:

FIG. 1.—Schematic sectioned view of the window and in the figure, identical elements are designated with the same reference and among them, the following can be identified:

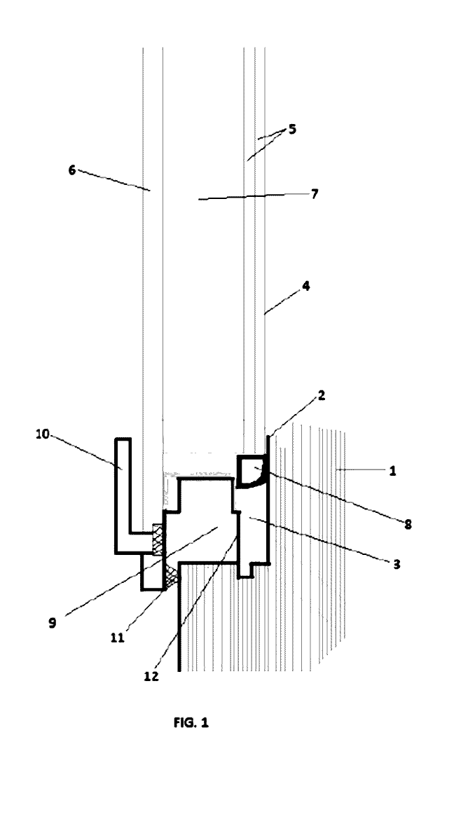

(1).—window frame

(2).—elastic element fixed to the frame.

(3).—decompression chamber.

(4).—Closing sheet.

(5).—laminated glass.

(6).—tempered glass.

(7).—vacuum chamber.

(8).—triangular elastic element.

(9).—Open/close fitting.

(10).—drive handle for the open/close fitting.

(11).—cushion type elastic element

(12).—Elastic support element

### PREFERRED EMBODIMENTS OF THE INVENTION

The proposed invention refers to a new window layout of the type of windows made up starting with a micro-laminated wood frame and several glass sheets with a built-in air chamber and that is constituted by a frame (1) made of micro-laminated wood, glued together with a strong adhesive and a closing sheet (4) constituted, from the outside to the inside, by a block of two laminated glass sheets and a sheet of thick tempered glass (6) of a larger size, and separated by a vacuum chamber (7).

The laminated glass sheets present a triangular elastic element (8) that encircles them along the perimeter and the sheet of tempered glass presents in its entire perimeter a cushion type elastic element (11).

The closing space between the frame (1) and the closing sheet (4) is occupied by a decompression chamber (3) attached to the frame (1), whose decompression chamber shows an elastic sheet adhered to by its free side that serves as a stop for the closing fitting (9) placed on the tempered glass (6) by means of an adhesive that entails a drive handle (10).

The nature of the invention sufficiently described, as well as the way to be embodied, it has to be noted that the layouts above described and represented in the attached drawings are susceptible to changes in detail, as long as these do not change the fundamental principles laid down in the previous paragraphs and summarized in the following claims.

1. Improved two pieces window characterized in that it is comprised by a frame (1) manufactured with micro-laminated woods, joined by strong adhesives and a closing sheet (4) constituted, from the outside to the inside by a block of two laminated glass sheets and a sheet of thick tempered glass (6), of a larger size, and separated by a vacuum chamber (7).

2. The laminated glass sheets present a triangular elastic element (8) that encircles them along the perimeter and the sheet of tempered glass presents in its entire perimeter a cushion type elastic element (11).

2. The closing space between the frame (1) and the closing sheet (4) is occupied by a decompression chamber (3) attached to the frame (1), whose decompression chamber shows an elastic sheet adhered to by its free side that serves as a stop for the closing fitting (9) placed on the tempered glass (6) by means of an adhesive that entails a drive handle (10).
